(19) United States
(12) Patent Application Publication
(10) Pub. No.: US 2022/0084053 A1
(43) Pub. Date: Mar. 17, 2022

(54) SOCIAL MEDIA DATA ANALYSIS AND MONETIZATION

(71) Applicant: Radient Technologies Innovations Inc., Edmonton (CA)

(72) Inventors: Michael Cabigon, Edmonton (CA); Jim Seethram, Edmonton (CA); Steven Aplinter, Edmonton (CA); Denis Taschuk, Edmonton, CA (US)

(21) Appl. No.: 17/240,196

(22) Filed: Apr. 26, 2021

Related U.S. Application Data
(63) Continuation of application No. PCT/US2019/058964, filed on Oct. 22, 2019.
(60) Provisional application No. 62/750,203, filed on Oct. 24, 2018.

(51) Int. Cl. G06Q 30/02; G06F 40/186; G06F 40/174; G06Q 50/00

(52) U.S. Cl. CPC G06Q 30/0203; G06Q 30/0205; G06Q 50/01; G06F 40/174; G06F 40/186

(57) ABSTRACT

This present disclosure is related to systems and methods of collecting and analyzing data from cannabis users (e.g., cannabis influencers and trend setters), social media websites that may geared towards deciphering cannabis trends and preferences. Such a system may allow the cannabis producers (growers, extractors, cannabis product manufacturers) to collect data about the effects and/or qualities of their product and may also allow users to be fully informed prior to purchasing. This system may generate reports on a monthly or weekly basis for the convenience of its users. It is a method of collecting feedback from users of cannabis concentrates via a social network that is geared to power users, influencers, and trend setters. The system is marketed to stakeholders that are making products for consumers, craft makers, and high-end users as a platform to exchange information about what concentrate profiles are best for different end products, along with processing steps. This is a subscription program for cannabis concentrate users that allows cannabis companies to collect data about the effects and/or qualities of their products.

### CROSS-REFERENCE TO RELATED APPLICATIONS

The present patent application is a continuation of International Application No. PCT/IB2019/058964 filed Oct. 22, 2019, which claims the priority benefit of U.S. provisional patent application 62/750,203 filed Oct. 24, 2018, the disclosures of which are incorporated by reference herein.

### BACKGROUND OF THE INVENTION

### 1. Field of the Disclosure

The present disclosure is generally related to methods for analyzing and monetizing user social media data for the cannabis industry.

### 2. Description of the Related Art

Cannabis is becoming increasingly available to the public for medicinal and social use. As a result, a plethora of cannabis products have flooded and continue to enter the market. Historically, when cannabis products discreetly entered the black market, products were relatively limited such that the demand for any cannabis would drive the market. However, as the market becomes saturated with multiple products, the user now has many options to pick and choose from. User preference now drives the market. Unfortunately, due to multiple tracking issues, it is difficult for stakeholders in the cannabis industry to decipher the right strain or product form to focus on.

Stakeholders such as investors, growers, manufacturers, and dispensaries do not have all the information to determine the best cannabis strain and subsequent product to invest their time and money. Similarly, users of cannabis do not have all the information to determine the type of product best suited for their needs. As users of cannabis products develop preferences and aversions to specific products, the aggregate user data can provide insight into both the production stakeholders and the direct user stakeholders.

Currently there is no streamlined location that a user can visit to answer questions of preference. At best, the user may enter a dispensary and request for a consultation. However, a dispensary will only discuss the product that the dispensary has in stock or would be willing to stock. Each dispensary may have similar products but different names identifying very similar, if not identical, products. Users have limited tools to wade through the confusing names and consumption methods.

Along the same lines, the producers of cannabis products (e.g., growers, manufacturers, and dispensaries) also do not have a central location to receive a survey of the user preference to guide their production decisions. There is a need to generate and analyze consumer data to provide enhanced services to stakeholders of cannabis and cannabis products. A solution is needed to create a central platform to exchange information about cannabis products, such as information regarding dried flowers, cannabis strains, extracts, concentrates, cannabis-infused edibles, vapables, topicals, and other cannabis products.

This present disclosure is related to systems and methods of collecting and analyzing data from cannabis users (e.g., cannabis influencers and trend setters), social media websites that may geared towards deciphering cannabis trends and preferences. Such a system may allow the cannabis producers (growers, extractors, cannabis product manufacturers) to collect data about the effects and/or qualities of their product and may also allow users to be fully informed prior to purchasing. This system may generate reports on a monthly or weekly basis for the convenience of its users.

### BRIEF DESCRIPTIONS OF THE DRAWINGS

FIG. 1 illustrates an exemplary network environment in which a system for social media data analysis and monetization may be implemented.

FIG. 2 is a flowchart illustrating an exemplary method for receiving and correlating cannabis social media data.

FIG. 3 is a flowchart illustrating an exemplary method for generating and monetizing cannabis social media data reports.

FIG. 4 is a table illustrating exemplary user data that may be included in a user database.

FIG. 5 is a table illustrating exemplary demographic data that may be included in a demographic database.

FIG. 6 is a table illustrating exemplary cannabis strain data that may be included in a cannabis strain database.

### DETAILED DESCRIPTION

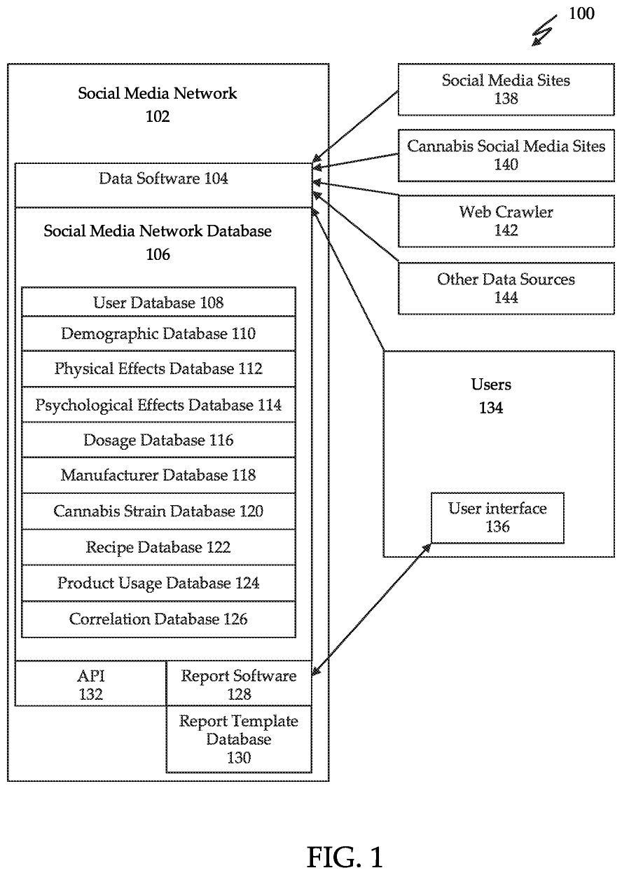

Embodiments of the present disclosure include systems and methods for analyzing and monetizing cannabis social media data. FIG. 1 is a block diagram illustrating an exemplary cannabis social media network system 100 for social media data analysis and monetization. The social media network system 100 may include a social media network 102, users 134, social media sites 138, cannabis social media sites 140, web crawler 142, and other data sources 144. The system 100 may be understood as a network in the cloud that may aggregate to analyze data from unlimited internet sources that may generate an accurate picture of the attributes, trends, and preferences related to a product and its users 134.

The social media network 102 is a network for providing social medial network services to cannabis manufacturers and consumers. The social media network 102 may include a data software 104, a report software 128, a social media network database 106, report templates database 130, an application program interface (API) 132. The data software 104 is software for receiving social media data and calculating correlations between the data to be stored in the correlation database 126 within the social media network database.

The social media network database 106 is a database that may contain multiple various social media databases. The social media network database 106 may include user database 108, demographic database 110, physical effects database 112, psychological effects database 114, dosage database 116, manufacturer database 118, cannabis strain database 120, recipe database 122, product usage database 124, and correlation database 126. The user database 108 may contain data that may identify various users. The demographic database 110 may include demographic data regarding the various users. The physical effects database 112 may contain data on the physical effects of cannabis usage on the various users. The psychological effects database 114 may include data on the psychological effects of cannabis usage on the various users. The dosage database 116 may contain data on the dosages taken by the various users. The manufacturer database 118 may contain data provided by the manufacturer describing the manufacturing entity, processes, and other data concerning growing, extracting, or manufacturing of the cannabis. The cannabis strain database 120 may contain data regarding the strain of cannabis used by the user. The recipe database 122 may contain data containing recipes used by users containing cannabis. The product usage database 124 may contain data on the specific manufactured cannabis products used by users. The correlation database 126 may contain continually-updated data that shows the correlations that may be used in the reports generated by the report software 128.

The report software 128 is software for receiving user requests for reports, charging users for the report, and then sending the report to one or more users. The report template database 130 is a database of template fillable forms. Upon request for a particular report type, the user will receive a corresponding template form that contains the appropriate field that allows the user to fill out their request. The user 134 may specify the types of data to be in their report. The template will also include a location for the user to indicate payment information. New report templates may be created in response to market needs. In one embodiment, the report software 128 may be configured to automatically charge and send updated reports to the user 134.

The API 132 is an interface that is a set of subroutine definitions, communication protocols, and tools for building software. In general terms, it is a set of clearly defined methods of communication between various components on the internet. The API 132 allows software applications to request data from the social media network 102. For example, other data sources 144 may be applications that are given permission to access the API 132 to pull specific but limited data from the social media network database 106. For example, another application may auto populate their site with the types of reports that is available for purchase by the report software 128.

The users 134 may be individuals or entities that purchase, use, produce, or invest in cannabis products. The users 134 may use the user interface software 136 to upload to the data software 104 data related to the user, user demographic, cannabis product, and other data. The user interface software 136 may also allow users 134 to request, submit payment, and receive reports on cannabis products and related user information.

The social media sites 138 are websites that are interactive computer-mediated technologies that facilitate the creation and sharing of information, ideas, blogs, career interests, and other forms of expression via virtual communities and networks. Examples of social media sites are Facebook, Instagram, YouTube, and Tumblr. The cannabis social media sites 140 are social media websites that are focused on the cannabis and marijuana cultures and groups. The web crawler 142 is an internet search engine that takes input from a user and simultaneously sends out queries to third party search engines to gather specific data. Gathered data are reviewed for sufficiency, ranked, and may be accessible to the users. The other data sources 144 are other data sources that do not fall under traditional websites or social media websites. Some examples may be geolocation software, health software, or messaging software (e.g., Whatsapp). Data from these sources may be analyzed and saved in the social media network database 106.

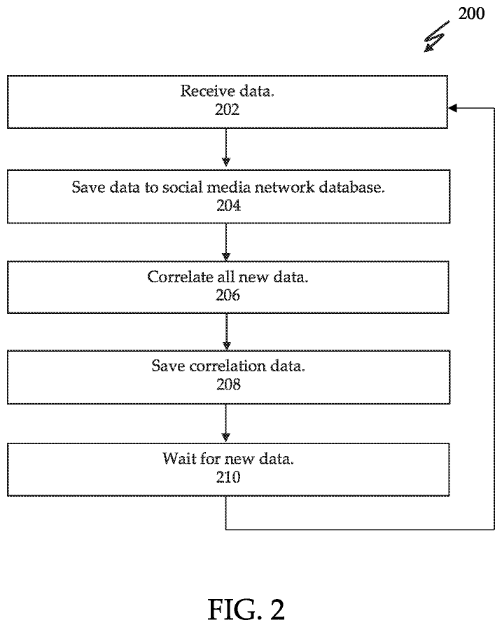

FIG. 2 is a flowchart 200 illustrating an exemplary method for receiving and correlating cannabis social media data. First, the data software 104 receives new data from a data source at step 202. Examples of data sources may be the social media sites 138 or the cannabis social media sites 140. The data software 104 may process the new data at step 202. Examples of processing may include parsing the new data by type, such as user data, demographic data, and recipe data. The new data is then saved to the appropriate data repositories or databases in the social media network database 106 at step 204. The data software 104 analyzes and compares the new data with the existing data stored in the social media network database 106 at step 206. The analysis may include identifying correlations between the data types and/or data sets containing the new data and all related data. An example correlation may be the identification of the most frequently used strain of cannabis used by users at a specific location. In one embodiment, such analysis may be conducted in real time at the time of request. In another embodiment, the analysis may be conducted continually as new data comes in. Correlations may be calculated by a number of means. The calculated correlation data is saved in the correlation database 128 at step 208. The data software 104 is ready to receive new data at step 210.

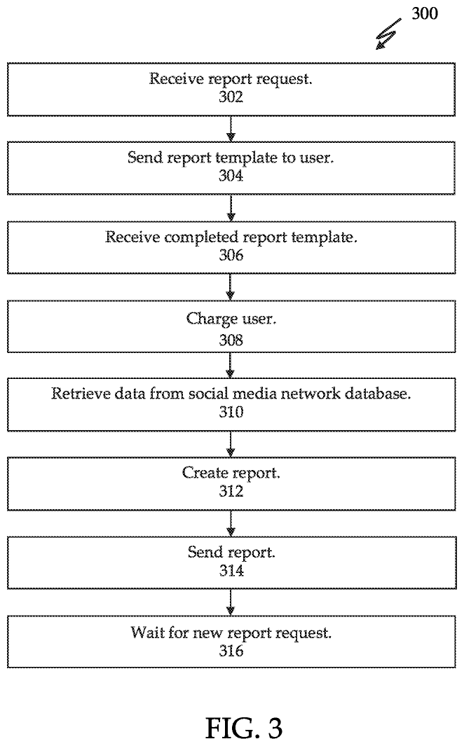

FIG. 3 is a flowchart 300 illustrating an exemplary method for generating and monetizing cannabis social media data reports. First, the report software 128 receives a user request for a specific type of report at step 302. The report software 128 sends a blank report template, corresponding to the user requested type of report, to the user to be completed at step 304. The report template contains fields for the user to indicate the specifics of the user request such as the data types requested, and a field to enter the user's payment information. The report software 128 receives the completed report template from the user at step 306. The payment information may be used to charge the user at step 308. The report software 128 retrieves the requested data from the social media network database 106 at step 310. The requested report is created using the retrieved data at 312. After payment has been received, the report software 128 sends the report to the user at step 314. The software 106 then waits for a new request to be received at step 316.

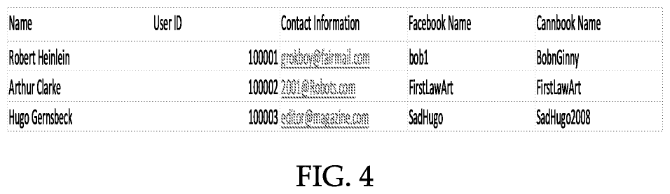

FIG. 4 is a table illustrating exemplary user data that may be included in a user database 110. The user database 110 may contain the user names that corresponds to a user identification number (ID), the user contact information, Facebook username, and Cannbook name. For example, FIG. 4 shows a user named Robert Heinlein with a user ID 100001, an email as the contact information, a Facebook username of “bob1,” and a Cannbook name of “BobnGinny.”

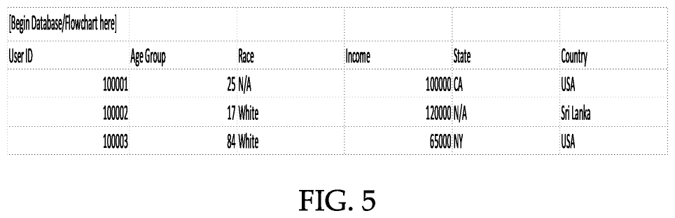

FIG. 5 is a table illustrating exemplary demographic data that may be included in the demographic database 112. The demographic database 112 may include demographic data of various users and other related data that may be used to determine certain correlations. For example, there may be a correlation that can identify a preferred usage pattern or preferred strain of cannabis corresponding to certain demographic groups. The demographic database 112 may include a user ID, and the user's age/age group, race, income, state, country. For example, FIG. 5 shows a user 100001 who is 25 years old, did not report his or her race, with an income of $100,000, who lives in California in the United States.

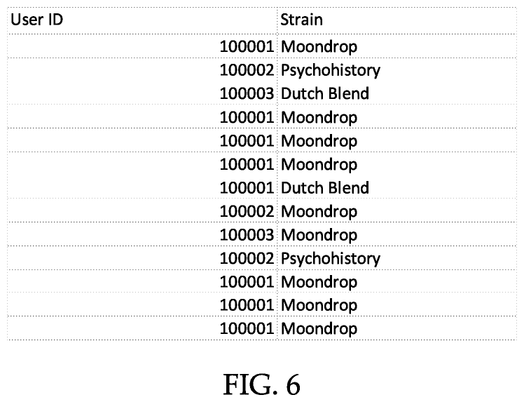

FIG. 6 is a table illustrating exemplary cannabis strain data that may be included in a cannabis strain database 122. The cannabis strain database 122 may contain data regarding preferred strain usage by users. In one embodiment, the user's preference may be compared to other users of similar attributes or demographics to extrapolate a preference for a locale. For example, analysis of the data may reveal that users in the United States generally have a preference for a Cannabis strain known as “Moondrop.” FIG. 4 shows a list of users identified by their user ID and their preferred strain, which may be Moondrop, “Psychohistory” or “Dutch Blend.”

What is claimed is:

1. A method for analyzing and monetizing social media data, the method comprising:
storing a plurality of user profiles in memory, each user profile including one or more attributes regarding a respective user;
storing data regarding a plurality of cannabis products by at least one of the users, wherein the data is associated with the user profile;
receiving a user request for a report on one or more of the cannabis products;
generating correlation data that identifies at least one correlation between one of the attributes and one of the cannabis products; and
generating a report in response to the user request, wherein the report includes at least a portion that is unique to the user request based on the user profile of the requesting user.

2. The method of claim 1, further comprising continuously generating updated correlation data based on new data regarding the cannabis products, and storing the updated correlation data in a database in memory.

3. The method of claim 1, wherein the attributes include demographical information regarding the respective user.

4. The method of claim 1, wherein the user request further specifies a type of data associated with at least one of the attributes of the requesting user.

5. The method of claim 1, wherein the user request further specifies a type of data regarding the one or more cannabis products.

6. The method of claim 1, wherein the user request further specifies a type of data regarding associated with the manufacturer.

7. The method of claim 1, wherein the user request specifies a type of preference.

8. The method of claim 1, wherein generating the report is based on a report template.

9. The method of claim 8, wherein the report template is modifiable.

10. The method of claim 1, wherein the report requires payment information to unlock at least a portion of the report.

11. The method of claim 1, further comprising charging the user prior to generating the report.

12. The method of claim 1, further comprising transmitting the report periodically based on a subscription.

13. The method of claim 1, further comprising receiving the data regarding the plurality of cannabis products from a manufacturer.

14. The method of claim 1, further comprising retrieving the data regarding the plurality of cannabis product from a plurality of websites.

15. The method of claim 1, further comprising receiving data regarding a plurality of cannabis product web crawlers.

16. The method of claim 1, wherein the data regarding the plurality of cannabis products is from a plurality of different sources, and further comprising aggregating the data from the plurality of different sources.

17. The method of claim 16, wherein generating the correlation data is based on the aggregated data.

18. The method of claim 1, further comprising generating an updated report when the aggregated results in a new correlation, and sending the updated report to the requesting user based on payment authorization.

19. A system of analyzing and monetizing social media data, the system comprising:
a database in memory, wherein the database:
stores a plurality of user profiles, each user profile including one or more attributes regarding a respective user, and
stores data regarding a plurality of cannabis products by at least one of the users, wherein the data is associated with the user profile
a communication network interface that receives a user request for a report on one or more of the cannabis products; and
a processor that executes instructions stored in memory, wherein the processor executes instructions to:
generates correlation data that identifies at least one correlation between one of the attributes and one of the cannabis products; and
generates a report in response to the user request, wherein the report includes at least a portion that is unique to the user request based on the user profile of the requesting user.

20. A non-transitory, computer-readable storage medium, having embodied thereon a program executable by a processor to perform a method of analyzing and monetizing social media data, the method comprising:
storing a plurality of user profiles in memory, each user profile including one or more attributes regarding a respective user;
storing data regarding a plurality of cannabis products by at least one of the users, wherein the data is associated with the user profile;
receiving a user request for a report on one or more of the cannabis products;
generating correlation data that identifies at least one correlation between one of the attributes and one of the cannabis products; and
generating a report in response to the user request, wherein the report includes at least a portion that is unique to the user request based on the user profile of the requesting user.
